(19) United States
(12) Patent Application Publication
(10) Pub. No.: US 2026/0160978 A1
(43) Pub. Date: Jun. 11, 2026

(54) OPTICAL IMAGING LENS

(71) Applicant: GUANGZHOU LUXVISIONS INNOVATION TECHNOLOGY LIMITED, Guangzhou City (CN)

(72) Inventor: Yi-Wei Liu, Guangzhou City (CN)

(73) Assignee: GUANGZHOU LUXVISIONS INNOVATION TECHNOLOGY LIMITED, Guangzhou City (CN)

(21) Appl. No.: 19/292,942

(22) Filed: Aug. 7, 2025

Related U.S. Application Data
(60) Provisional application No. 63/729,470, filed on Dec. 9, 2024.

(30) Foreign Application Priority Data
Mar. 4, 2025 (CN) 202510251191.7

(51) Int. Cl. G02B 13/00; G02B 9/34

(52) U.S. Cl. CPC G02B 13/004; G02B 9/34; G02B 13/0055

(57) ABSTRACT

An optical imaging lens of the disclosure includes a first lens, a double-plano component, an aperture, a second lens, a third lens and a fourth lens in sequence from an object side to an image side along an optical axis. The first lens to the fourth lens and the double-plano component each include an object-side surface facing the object side and allowing an imaging light to pass through, and an image-side surface facing the image side and allowing the imaging light to pass through. A material of the double-plano component includes glass or plastic. A refractive index of the double-plano component is between 1.450 and 1.850. Refractive powers of the first lens, the double-plano component, the second lens, the third lens and the fourth lens are negative, zero, negative, positive and positive in sequence. Only the four lenses in the optical imaging lens have non-zero refractive power.

### CROSS-REFERENCE TO RELATED APPLICATION

This application claims the priority benefit of U.S. provisional application Ser. No. 63/729,470, filed on Dec. 9, 2024 and China application serial no. 202510251191.7, filed on Mar. 4, 2025. The entirety of each of the above-mentioned patent applications is hereby incorporated by reference herein and made a part of this specification.

### BACKGROUND

### Technical Field

The disclosure relates to an optical component, and in particular relates to an optical imaging lens.

### Description of Related Art

Wafer level optical process lens are formed by exposure and curing of UV glue on a glass substrate, creating a lens surface capable of refracting light. Each glass substrate undergoes exposure and formation processes on both sides to create a lens with bilateral refractive properties. Prior to being segmented into individual lens units, the glass substrate may conform to standard wafer dimensions of 4 inches, 6 inches, 8 inches, or 12 inches in diameter. That is, an 8-inch wafer glass substrate may accommodate thousands of lenses formed through UV exposure curing. However, a significant disadvantage of this methodology is that the thickness of the lens substrate limits the potential lens shape.

### SUMMARY

An optical imaging lens, which may use resin material injection molding or glass molding technology for lens molding and stacking assembly of the overall structure, is provided in the disclosure, thereby simplifying the process, improving the production yield, saving manufacturing costs, and having good optical properties.

An optical imaging lens of the disclosure includes a first lens, a double-plano component, an aperture, a second lens, a third lens and a fourth lens in sequence from an object side to an image side along an optical axis. The first lens to the fourth lens and the double-plano component each include an object-side surface facing the object side and allowing an imaging light to pass through, and an image-side surface facing the image side and allowing the imaging light to pass through. A material of the double-plano component includes glass or plastic. A refractive index of the double-plano component is between 1.450 and 1.850. Refractive powers of the first lens, the double-plano component, the second lens, the third lens and the fourth lens are negative, zero, negative, positive and positive in sequence. Only the four lenses in the optical imaging lens have non-zero refractive power. Only the four lenses in the optical imaging lens have non-zero refractive power, and a thickness of the double-plano component satisfies the following conditional formula: 0.200≥TE/TTL≥0.049, wherein TE is the thickness of the double-plano component on the optical axis, and TTL is a distance from the object-side surface of the first lens to an imaging surface on the optical axis.

In one embodiment of the disclosure, an aperture value of the optical imaging lens is between 3.000 and 6.000.

In one embodiment of the disclosure, a thickness of the double-plano component on the optical axis is between 0.100 mm and 0.550 mm.

In one embodiment of the disclosure, the optical imaging lens further satisfies a following conditional formula: −0.709≥F1/EFL≥−1.235, wherein F1 is an effective focal length of a combination of the first lens, the double-plano component and the second lens, and EFL is an effective focal length of the optical imaging lens.

In one embodiment of the disclosure, the optical imaging lens further satisfies a following conditional formula: 0.850≥F2/EFL≥0.590, wherein F2 is an effective focal length of a combination of the third lens and the fourth lens, and EFL is an effective focal length of the optical imaging lens.

In one embodiment of the disclosure, the optical imaging lens further satisfies a following conditional formula: 2.910≥TTL/ImgC≥1.700, wherein TTL is a distance from the object-side surface of the first lens to the imaging surface on the optical axis, and ImgC is an image circle of the optical imaging lens.

In one embodiment of the disclosure, the optical imaging lens further satisfies a following conditional formula: 0.266≥CA1/TTL≥0.150, wherein CA1 is a clear aperture of the first lens, and TTL is a distance from the object-side surface of the first lens to the imaging surface on the optical axis.

In one embodiment of the disclosure, the optical imaging lens further satisfies a following conditional formula: 1.200≥DM/ImgC≥0.600, wherein DM is a diameter of the optical imaging lens, and ImgC is an image circle of the optical imaging lens.

In one embodiment of the disclosure, an air gap at lens component edges between the first lens to the fourth lens ranges from 0.001 mm to 0.300 mm.

In one embodiment of the disclosure, the optical imaging lens satisfies one of following conditions: (1) materials of the first lens to the fourth lens are all plastic; (2) materials of the first lens to the fourth lens are all glass; and (3) materials of the first lens and the fourth lens are glass, and materials of the second lens and the third lens are plastic.

Based on the above, in an optical fingerprint imaging device of the disclosure, an optical imaging lens includes a first lens, a double-plano component, an aperture, a second lens, a third lens and a fourth lens in sequence from an object side to an image side along an optical axis. Refractive powers of the first lens, the double-plano component, the second lens, the third lens and the fourth lens are negative, zero, negative, positive and positive in sequence. Only the four lenses in the optical imaging lens have non-zero refractive power. A thickness of the double-plano component satisfies the following conditional formula: 0.200≥TE/TTL≥0.049, wherein TE is the thickness of the double-plano component on the optical axis, and TTL is a distance from the object-side surface of the first lens to an imaging surface on the optical axis. Therefore, by disposing a double-plano component made of glass or plastic immediately after the first lens, and then using the grooves or latches formed by the outer skirt of the lens and then applying glue to cure it, the lens molding and stacking assembly of the overall structure of the optical imaging lens may all use resin material injection molding or glass molding technology, which is different from the conventional wafer level optical process lens that uses UV glue molding, where an entire glass substrate is stacked and cured before proceeding with unit segmentation. As a result, the optical imaging lens of this embodiment may simplify the process, improve the production yield, save manufacturing costs, and provide good optical properties.

### BRIEF DESCRIPTION OF THE DRAWINGS

The accompanying drawings are included to provide a further understanding of the disclosure, and are incorporated in and constitute a part of this specification. The drawings illustrate embodiments of the disclosure, and together with the description serve to explain principles of the disclosure.

FIG. 1 is a schematic diagram of an optical imaging lens of an embodiment of the disclosure.

FIG. 2 is a schematic diagram of distortion of the optical imaging lens of FIG. 1.

FIG. 3 is a schematic diagram of lateral chromatic aberration distribution of the optical imaging lens of FIG. 1.

FIG. 4 to FIG. 7 are modulation transfer function curve diagrams of the optical imaging lens of FIG. 1.

FIG. 8 is a schematic diagram of an optical imaging lens of another embodiment of the disclosure.

FIG. 9 is a schematic diagram of distortion of the optical imaging lens of FIG. 8.

FIG. 10 is a schematic diagram of lateral chromatic aberration distribution of the optical imaging lens of FIG. 8.

FIG. 11 to FIG. 14 are modulation transfer function curve diagrams of the optical imaging lens of FIG. 8.

FIG. 15 is a schematic diagram of an optical imaging lens of another embodiment of the disclosure.

FIG. 16 is a schematic diagram of distortion of the optical imaging lens of FIG. 15.

FIG. 17 is a schematic diagram of lateral chromatic aberration distribution of the optical imaging lens of FIG. 15.

FIG. 18 to FIG. 22 are modulation transfer function curve diagrams of the optical imaging lens of FIG. 15.

FIG. 23 is a schematic diagram of an application of a double-plano component according to an embodiment of the disclosure.

### DETAILED DESCRIPTION OF DISCLOSED EMBODIMENTS

References of the exemplary embodiments of the disclosure are to be made in detail. Examples of the exemplary embodiments are illustrated in the drawings. If applicable, the same reference numerals in the drawings and the descriptions indicate the same or similar parts.

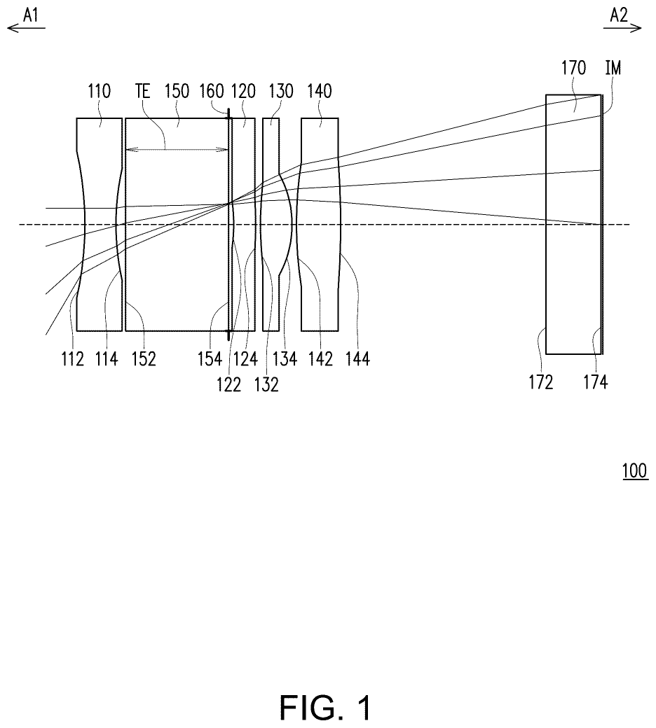

FIG. 1 is a schematic diagram of an optical imaging lens of an embodiment of the disclosure. Referring to FIG. 1, an optical imaging lens 100 provided in this embodiment may be applied to bronchoscopes, pharyngoscopes, cystoscopes, cardiac catheterization surgery, ovarian surgery, minimally invasive surgery, capsule endoscopy, or may be used in micro lenses such as eye tracking modules of wearable devices, otoscopes, and detection lenses integrated within earphones. A first lens 110, a double-plano component 150, an aperture 160, a second lens 120, a third lens 130, a fourth lens 140 and a filter 170 in sequence are included from an object side A1 to an image side A2 along an optical axis I. When light emitted by an object to be photographed enters the optical imaging lens 100 and passes through the first lens 110, the double-plano component 150, the aperture 160, the second lens 120, the third lens 130, the fourth lens 140 and the filter 170, an image is formed on an imaging surface IM. It should be clarified that the object side A1 is the side facing the object to be photographed, and the image side A2 is the side facing the imaging surface IM.

In this embodiment, the first lens 110, the second lens 120, the third lens 130, the fourth lens 140, the double-plano component 150, and the filter 170 of the optical imaging lens 100 each have an object-side surface 112, 122, 132, 142, 152 and 172 facing the object side A1 and allowing an imaging light to pass through, and an image-side surface 114, 124, 134, 144, 154 and 174 facing the image side A2 and allowing the imaging light to pass through. In this embodiment, the aperture 160 is disposed on a side of the double-plano component 150 facing the image side A2. In this embodiment, an aperture value of the optical imaging lens 100 is between 3.000 and 6.000.

The first lens 110 has a negative refractive power. The object-side surface 112 of the first lens 110 is a concave surface, and the image-side surface 114 is a concave surface. In this embodiment, both the object-side surface 112 and the image-side surface 114 of the first lens 110 are aspheric surfaces, but the disclosure is not limited thereto.

The second lens 120 has a negative refractive power. The object-side surface 122 of the second lens 120 is a concave surface, and the image-side surface 124 is a convex surface. In this embodiment, both the object-side surface 122 and the image-side surface 124 of the second lens 120 are aspherical surfaces, but the disclosure is not limited thereto.

The third lens 130 has a positive refractive power. The object-side surface 132 of the third lens 130 is a convex surface, and the image-side surface 134 is a convex surface. In this embodiment, both the object-side surface 132 and the image-side surface 134 of the third lens 130 are aspherical surfaces, but the disclosure is not limited thereto.

The fourth lens 140 has positive refractive power. The object-side surface 142 of the fourth lens 140 is a convex surface, and the image-side surface 144 is a convex surface. In this embodiment, both the object-side surface 142 and the image-side surface 144 of the fourth lens 140 are aspherical surfaces, but the disclosure is not limited thereto.

Only the four lenses in the optical imaging lens 100 have non-zero refractive power, that is, the first lens 110 to the fourth lens 140. In addition, the air gaps at the lens component edges between the first lens 110 to the fourth lens 140 range from 0.001 mm to 0.300 mm. In addition, in one embodiment, the materials of the first lens 110 to the fourth lens 140 may all be plastic. Alternatively, in another embodiment, the materials of the first lens 110 to the fourth lens 140 are all glass. Alternatively, in yet another embodiment, the materials of the first lens 110 and the fourth lens 140 are glass, and the materials of the second lens 120 and the third lens 130 are plastic. However, the disclosure is not limited thereto.

The refractive index of the double-plano component 150 is zero. The object-side surface 152 of the double-plano component 150 is a plane, and the image-side surface 154 is a plane. The material of the double-plano component 150 includes, for example, glass or plastic, and the refractive index thereof is between 1.450 and 1.850. The thickness of the double-plano component 150 on the optical axis I is between 0.100 mm and 0.550 mm. In this embodiment, the thickness TE of the double-plano component 150 satisfies the following conditional formula: 0.200≥TE/TTL≥0.049, wherein TE is the thickness of the double-plano component 150 on the optical axis I, and TTL is the distance from the object-side surface 112 of the first lens 110 to the imaging surface IM on the optical axis I.

Other detailed optical data of this embodiment are shown in Table 1 below. The field of view (FOV) of the optical imaging lens 100 of this embodiment is 120 degrees, and the aperture value (F-number, Fno) is 5.

TABLE 1
First Embodiment
Sensor Format = 1/18″, Image Circle = 1 mm,
TTL = 2.503 mm, Maximum clear aperture = 0.5723 mm,
Lens diameter = 0.82 mm, Range of TLL/IC = 2.127 to 2.878,
Thickness of double-plano component (TE) = 0.4 mm,
Range of TE/TLL = 0.1358 to 0.1838

| | | Radius of | | Refractive | Abbe |
|---|---|---|---|---|---|
| | | curvature | Thickness | Index | number |
| Component | Surface | (mm) | (mm) | (nd) | (Vd) |
| First lens 110 | Object-side | −1.902 | 0.120 | 1.54 | 56.0 |
| | surface 112 | | | | |
| | Image-side | 0.928 | 0.035 | | |
| | surface 114 | | | | |
| Double-plano | Object-side | Infinite | 0.400 | Glass or plastic | |
| component 150 | surface 152 | | | | |
| | Image-side | Infinite | 0.020 | | |
| | surface 154 | | | | |
| Second lens 120 | Object-side | −0.520 | 0.084 | 1.66 | 20.4 |
| | surface 122 | | | | |
| | Image-side | −1.280 | 0.020 | | |
| | surface 124 | | | | |
| Third lens 130 | Object-side | 1.255 | 0.119 | 1.54 | 56.0 |
| | surface 132 | | | | |
| | Image-side | −0.434 | 0.020 | | |
| | surface 134 | | | | |
| Fourth lens 140 | Object-side | 1.494 | 0.169 | 1.54 | 56.0 |
| | surface 142 | | | | |
| | Image-side | −3.275 | 0.796 | | |
| | surface 144 | | | | |
| Filter 170 | Object-side | Infinite | 0.210 | 1.52 | 62.0 |
| | surface 172 | | | | |
| | Image-side | Infinite | 0.010 | | |
| | surface 174 | | | | |
| | Imaging | Infinite | 0.000 | | |
| | surface IM | | | | |

In addition, in this embodiment, the object-side surfaces 112, 122, 132 and 142 and the image-side surfaces 114, 124, 134 and 144 of the first lens 110, the second lens 120, the third lens 130 and the fourth lens 140, a total of eight surfaces, are aspherical surfaces. The object-side surfaces 112, 122, 132 and 142 and the image-side surfaces 114, 124, 134 and 144 are typical even asphere surfaces. These aspheric surfaces are defined according to the following formula (1):

$$Z ( Y ) = \frac{{Y}^{2}}{R} / ( 1 + \sqrt{1 - ( 1 + K ) \frac{{Y}^{2}}{{R}^{2}}} ) + \text{?} \times {Y}^{i} \qquad ( 1 )$$

$$\text{?} \text{indicates text missing or illegible when filed}$$

wherein:
Y: the vertical distance between a point on the aspheric curve and the optical axis I;
Z: the depth of the aspheric surface (the vertical distance between a point on the aspheric surface at a distance Y from the optical axis I and the tangent plane touching the apex of the aspheric surface on the optical axis I);
R: radius of curvature of the lens surface close to the optical axis I;
K: the conic constant.
ai: i^{th} order aspheric coefficient.

The aspheric coefficients of the object-side surface 112 of the first lens 110 to the image-side surface 144 of the fourth lens 140 in Formula (1) are shown in Table 2 below. The field number 112 in Table 2 indicates the aspheric coefficients of the object-side surface 112 of the first lens 110, and the other fields may be deduced by analogy. In this embodiment, the second-order aspheric coefficient a₂ of each aspheric surface is zero, and therefore is not listed in Table 2.

TABLE 2

| Surface | K | a₄ | a₆ | a₈ | a₁₀ | a₁₂ | a₁₄ |
|---|---|---|---|---|---|---|---|
| 112 | 0.000 | −1.42 | −9.12 | 51.46 | 845.95 | −2058.71 | −32215.78 |
| 114 | 3.400 | 0.83 | −161.84 | 3998.54 | −36614.22 | −163445.86 | 4732111.34 |
| 122 | 0.000 | −8.99 | −132.76 | 35560.53 | 26644605.05 | 0.00 | 0.00 |
| 124 | 0.000 | 3.89 | 52.66 | 2668.70 | 0.00 | 0.00 | 0.00 |
| 132 | 26.983 | −2.12 | −60.04 | −677.61 | 15708.41 | 0.00 | 0.00 |
| 134 | 0.788 | 1.43 | 7.55 | −43.74 | −3106.47 | 334127.40 | 0.00 |
| 142 | 23.454 | −0.71 | −0.11 | 394.07 | −4433.35 | −40892.62 | 0.00 |
| 144 | 0.000 | 0.00 | 0.00 | 0.00 | 0.00 | 0.00 | 0.00 |

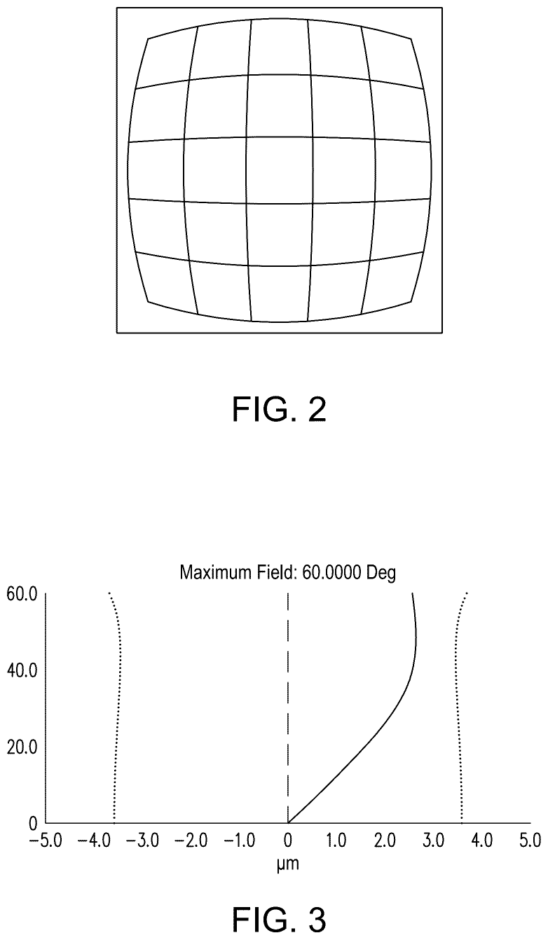

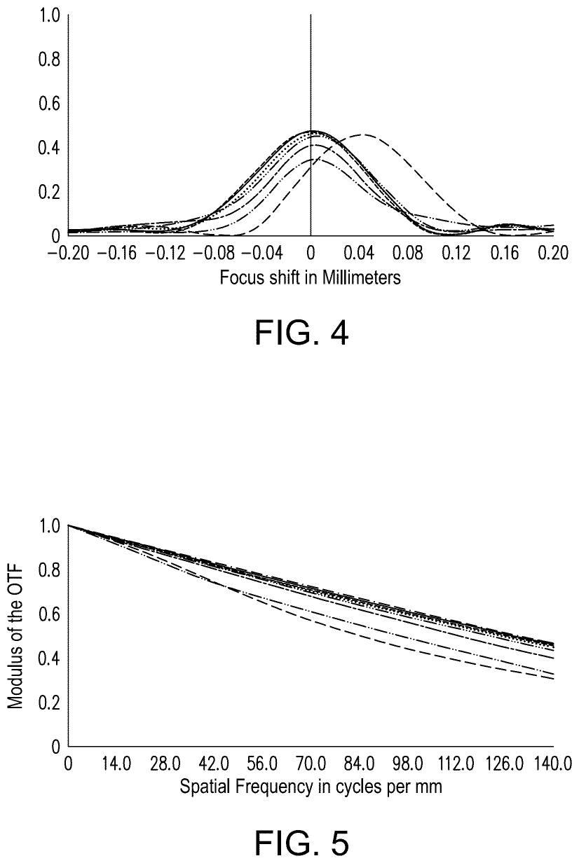

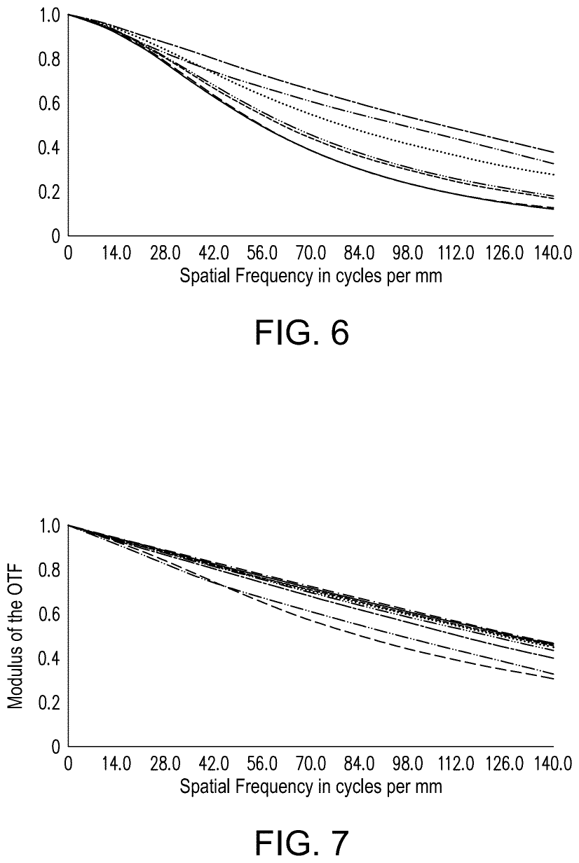

FIG. 2 is a schematic diagram of distortion of the optical imaging lens of FIG. 1. FIG. 3 is a schematic diagram of lateral chromatic aberration distribution of the optical imaging lens of FIG. 1. FIG. 4 to FIG. 7 are modulation transfer function curve diagrams of the optical imaging lens of FIG. 1. Referring to FIG. 2 to FIG. 7, FIG. 2 illustrates the distortion performance of the optical imaging lens 100 of this embodiment, in which the maximum distortion is −57.099% and the TV distortion is −24.313%. FIG. 3 shows the lateral chromatic aberration distribution of the optical imaging lens 100. As shown in the figure, the difference in focal points of the three colors of visible light (RGB) is less than 3 μm. FIG. 4 shows the MTF performance of the optical imaging lens 100 through the focal point at a spatial frequency of 140 lp/mm. FIG. 5 shows the MTF performance of the optical imaging lens 100 not through the focal point at a spatial frequency of 140 lp/mm. FIG. 6 and FIG. 7 respectively show the MTF performance of the optical imaging lens 100 when the object distances are 5 mm and 50 mm. Therefore, this embodiment may indeed significantly improve optical aberration and provide good optical properties.

By disposing a double-plano component 150 made of glass or plastic immediately after the first lens 110, and then using the grooves or latches formed by the outer skirt of the lens and then applying glue to cure it, the lens molding and stacking assembly of the overall structure of the optical imaging lens 100 may all use resin material injection molding or glass molding technology, which is different from the conventional wafer level optical process lens that uses UV glue molding, where an entire glass substrate is stacked and cured before proceeding with unit segmentation. As a result, the optical imaging lens 100 of this embodiment may simplify the process, improve the production yield, save manufacturing costs, and provide good optical properties.

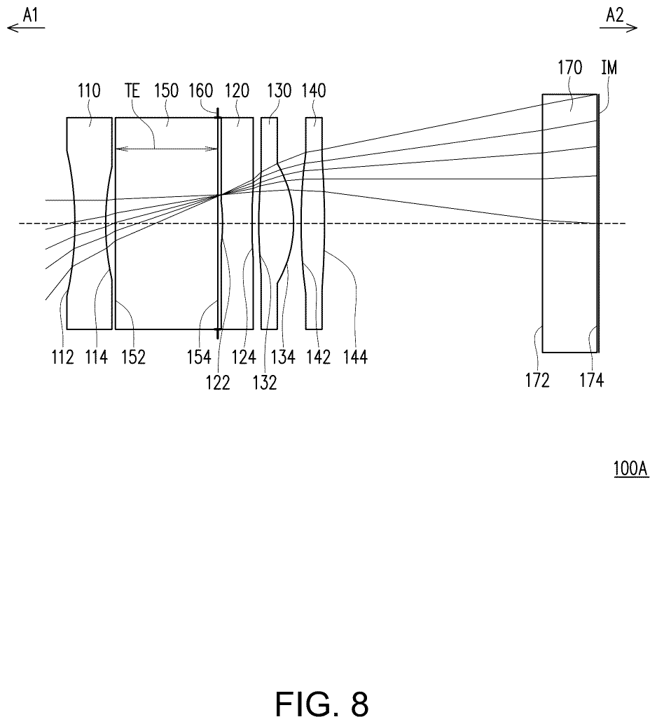

FIG. 8 is a schematic diagram of an optical imaging lens of another embodiment of the disclosure. Referring to FIG. 8, the optical imaging lens 100A of this embodiment is similar to the optical imaging lens 100 shown in FIG. 1. The differences between the two are as follows: the optical data, aspheric coefficients and parameters of the first lens 110, the second lens 120, the third lens 130, the fourth lens 140 and the double-plano component 150 are more or less different. In addition, in this embodiment, the image-side surface 134 of the third lens 130 is a concave surface.

Other detailed optical data of this embodiment are shown in Table 3 below. The field of view of the optical imaging lens 100A of this embodiment is 100 degrees, and the aperture value is 3.9.

TABLE 3
Second Embodiment
Sensor Format = 1/18″, Image Circle = 1 mm,
System length (TTL) = 2.53 mm, Maximum clear aperture = 0.5827 mm,
Lens diameter = 0.82 mm, Range of TLL/IC = 2.15 to 2.91,
Thickness of double-plano component (TE) = 0.41067 mm,
Range of TE/TLL = 0.1380 to 0.1867

| | | Radius of | | Refractive | Abbe |
|---|---|---|---|---|---|
| | | curvature | Thickness | Index | number |
| Component | Surface | (mm) | (mm) | (nd) | (Vd) |
| First lens 110 | Object-side | −4.205 | 0.120 | 1.54 | 56.0 |
| | surface 112 | | | | |
| | Image-side | 0.841 | 0.035 | | |
| | surface 114 | | | | |
| Double-plano | Object-side | Infinite | 0.411 | Glass or plastic | |
| component 150 | surface 152 | | | | |
| | Image-side | Infinite | 0.017 | | |
| | surface 154 | | | | |
| Second lens 120 | Object-side | −1.767 | 0.099 | 1.66 | 20.4 |
| | surface 122 | | | | |
| | Image-side | 2.937 | 0.020 | | |
| | surface 124 | | | | |
| Third lens 130 | Object-side | 1.359 | 0.141 | 1.54 | 56.4 |
| | surface 132 | | | | |
| | Image-side | −0.475 | 0.023 | | |
| | surface 134 | | | | |
| Fourth lens 140 | Object-side | 1.494 | 0.098 | 1.54 | 56.4 |
| | surface 142 | | | | |
| | Image-side | −3.077 | 0.847 | | |
| | surface 144 | | | | |
| Filter 170 | Object-side | Infinite | 0.210 | 1.52 | 61.0 |
| | surface 172 | | | | |
| | Image-side | Infinite | 0.010 | | |
| | surface 174 | | | | |
| | Imaging | Infinite | 0.000 | | |
| | surface IM | | | | |

As shown in Table 4 below, Table 4 shows the aspheric coefficients of the object-side surface 112 of the first lens 110 to the image-side surface 144 of the fourth lens 140 of the second embodiment in the aforementioned Formula (1).

TABLE 4

| Surface | K | a₄ | a₆ | a₈ | a₁₀ | a₁₂ | a₁₄ |
|---|---|---|---|---|---|---|---|
| 112 | 0.000 | −2.01 | −3.94 | 0.00 | 0.00 | 0.00 | 0.00 |
| 114 | 1.999 | −0.47 | −22.39 | −335.88 | −6002.15 | 30735.94 | 1171402.68 |
| 122 | 0.000 | −5.38 | −301.89 | −11175.37 | 2449616.38 | 0.00 | 0.00 |
| 124 | 0.000 | −1.27 | 13.61 | 997.18 | 0.00 | 0.00 | 0.00 |
| 132 | 23.516 | −1.17 | −9.31 | −350.99 | −5070.32 | 0.00 | 0.00 |
| 134 | 0.970 | 0.84 | −9.07 | 44.46 | −4977.63 | −1989.33 | 0.00 |
| 142 | 22.382 | −1.05 | −11.36 | 263.65 | −4826.30 | 16708.74 | 0.00 |
| 144 | 0.000 | 0.00 | 0.00 | 0.00 | 0.00 | 0.00 | 0.00 |

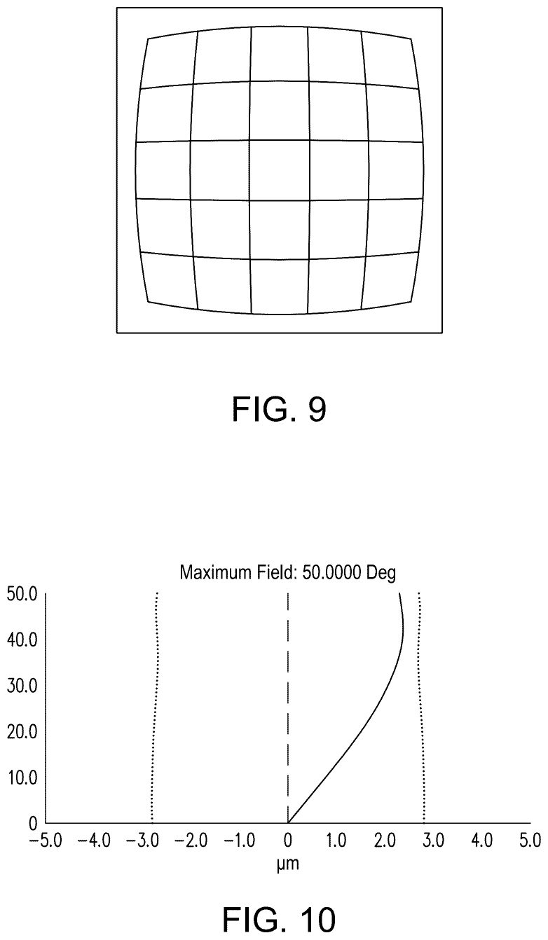

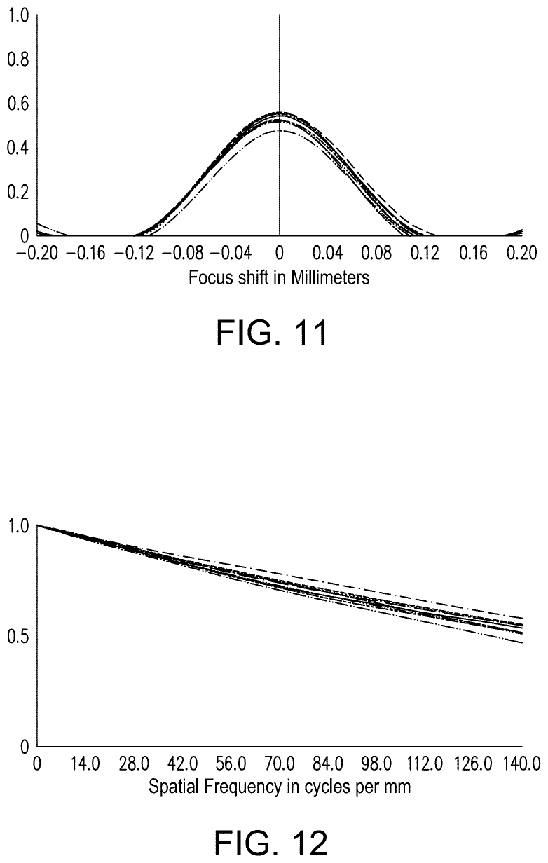

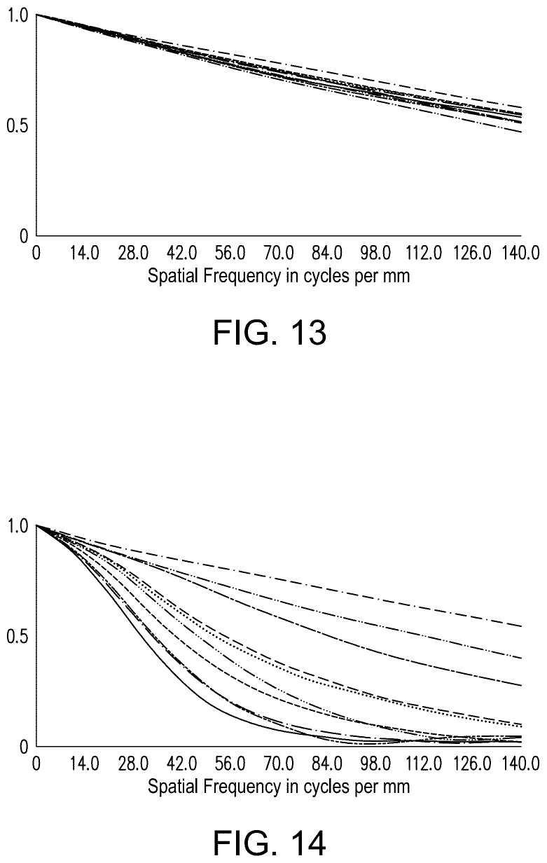

FIG. 9 is a schematic diagram of distortion of the optical imaging lens of FIG. 8. FIG. 10 is a schematic diagram of lateral chromatic aberration distribution of the optical imaging lens of FIG. 8. FIG. 11 to FIG. 14 are modulation transfer function curve diagrams of the optical imaging lens of FIG. 8. Referring to FIG. 9 to FIG. 14, FIG. 9 illustrates the distortion performance of the optical imaging lens 100A of this embodiment, in which the maximum distortion is −42.265% and the TV distortion is −19.426%. FIG. 10 shows the lateral chromatic aberration distribution of the optical imaging lens 100A. As shown in the figure, the difference in focal points of the three colors of visible light (RGB) is less than 2.5 μm. FIG. 11 shows the MTF performance of the optical imaging lens 100A through the focal point at a spatial frequency of 140 lp/mm. FIG. 12 shows the MTF performance of the optical imaging lens 100A not through the focal point at a spatial frequency of 140 lp/mm. FIG. 13 and FIG. 14 respectively show the MTF performance of the optical imaging lens 100A when the object distances are 50 mm and 5 mm. Therefore, this embodiment may indeed significantly improve optical aberration and provide good optical properties.

By disposing a double-plano component 150 made of glass or plastic immediately after the first lens 110, and then using the grooves or latches formed by the outer skirt of the lens and then applying glue to cure it, the lens molding and stacking assembly of the overall structure of the optical imaging lens 100A may all use resin material injection molding or glass molding technology, which is different from the conventional wafer level optical process lens that uses UV glue molding, where an entire glass substrate is stacked and cured before proceeding with unit segmentation. As a result, the optical imaging lens 100A of this embodiment may simplify the process, improve the production yield, save manufacturing costs, and provide good optical properties.

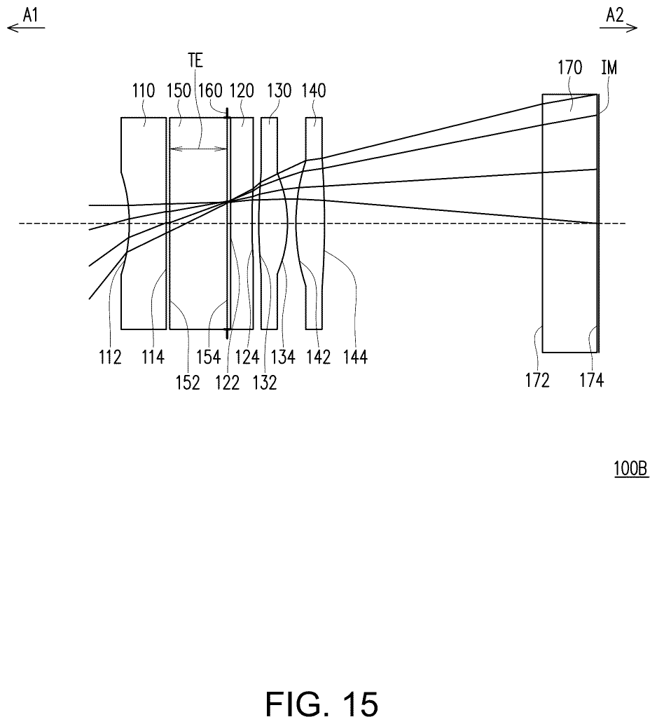

FIG. 15 is a schematic diagram of an optical imaging lens of another embodiment of the disclosure. Referring to FIG. 15, the optical imaging lens 100B of this embodiment is similar to the optical imaging lens 100 shown in FIG. 1. The differences between the two are as follows: the optical data, aspheric coefficients and parameters of the first lens 110, the second lens 120, the third lens 130, the fourth lens 140 and the double-plano component 150 are more or less different. Furthermore, in this embodiment, the object-side surface 122 of the second lens 120 is a convex surface, and the image-side surface 124 of the second lens 120 is a concave surface.

Other detailed optical data of this embodiment are shown in Table 5 below. The field of view of the optical imaging lens 100B of this embodiment is 100 degrees, and the aperture value is 5.3.

TABLE 5
Third Embodiment
Sensor Format = 1/18″, Image Circle = 1 mm,
System length (TTL) = 2.183 mm, Maximum clear aperture = 0.3846 mm,
Lens diameter = 0.76 mm, Range of TLL/IC = 1.855 to 2.51,
Thickness of double-plano component (TE) = 0.2 mm,
Range of TE/TLL = 0.073 to 0.1054

| | | Radius of | | Refractive | Abbe |
|---|---|---|---|---|---|
| | | curvature | Thickness | Index | number |
| Component | Surface | (mm) | (mm) | (nd) | (Vd) |
| First lens 110 | Object-side | −0.801 | 0.120 | 1.58 | 59.5 |
| | surface 112 | | | | |
| | Image-side | 3.310 | 0.020 | | |
| | surface 114 | | | | |
| Double-plano | Object-side | Infinite | 0.200 | Glass or plastic | |
| component 150 | surface 152 | | | | |
| | Image-side | Infinite | 0.010 | | |
| | surface 154 | | | | |
| Second lens 120 | Object-side | 7.437 | 0.083 | 1.64 | 22.4 |
| | surface 122 | | | | |
| | Image-side | 1.272 | 0.020 | | |
| | surface 124 | | | | |
| Third lens 130 | Object-side | 1.083 | 0.106 | 1.54 | 56.0 |
| | surface 132 | | | | |
| | Image-side | −0.484 | 0.023 | | |
| | surface 134 | | | | |
| Fourth lens 140 | Object-side | 1.153 | 0.095 | 1.58 | 59.5 |
| | surface 142 | | | | |
| | Image-side | −3.620 | 0.785 | | |
| | surface 144 | | | | |
| Filter 170 | Object-side | Infinite | 0.210 | BK7 | |
| | surface 172 | | | | |
| | Image-side | Infinite | 0.010 | | |
| | surface 174 | | | | |
| | Imaging | Infinite | 0.000 | | |
| | surface IM | | | | |

As shown in Table 6 below, Table 6 shows the aspheric coefficients of the object-side surface 112 of the first lens 110 to the image-side surface 144 of the fourth lens 140 of the third embodiment in the aforementioned Formula (1).

TABLE 6

| Surface | K | a₄ | a₆ | a₈ | a₁₀ | a₁₂ | a₁₄ |
|---|---|---|---|---|---|---|---|
| 112 | 0.000 | −4.65 | 8.27 | 0.00 | 0.00 | 0.00 | 0.00 |
| 114 | 17.299 | 0.35 | −77.67 | −2543.94 | −32471.57 | 1090576.52 | 140133530.35 |
| 122 | 0.000 | 0.00 | 0.00 | 0.00 | 0.00 | 0.00 | 0.00 |
| 124 | 0.000 | 0.00 | 0.00 | 0.00 | 0.00 | 0.00 | 0.00 |
| 132 | 9.898 | −1.94 | 272.89 | 6114.03 | −242537.40 | 0.00 | 0.00 |
| 134 | 0.975 | 3.15 | 7.38 | −7650.51 | 0.00 | 0.00 | 0.00 |
| 142 | 16.622 | −2.69 | −22.06 | −105.76 | 8415.06 | 0.00 | 0.00 |
| 144 | 0.000 | 0.67 | 15.23 | 454.68 | 862.34 | 280439.80 | 0.00 |

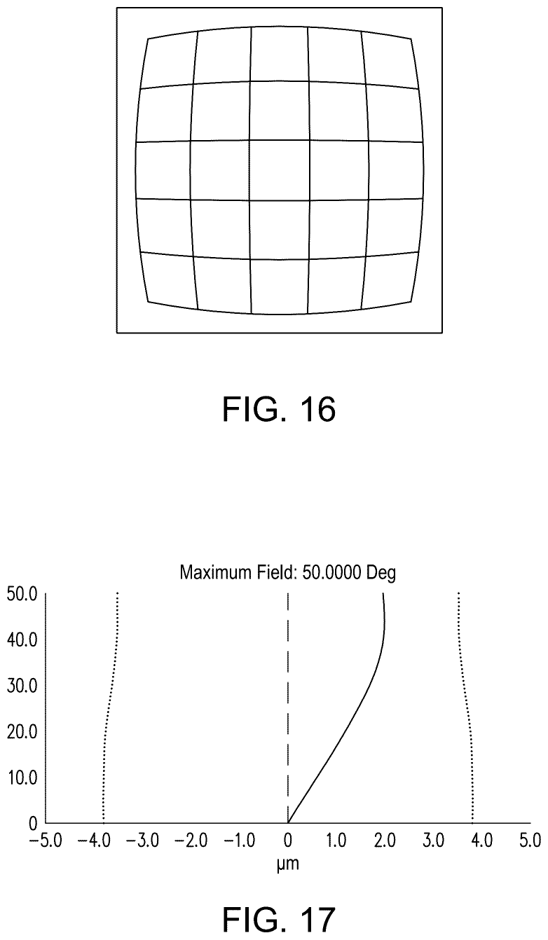

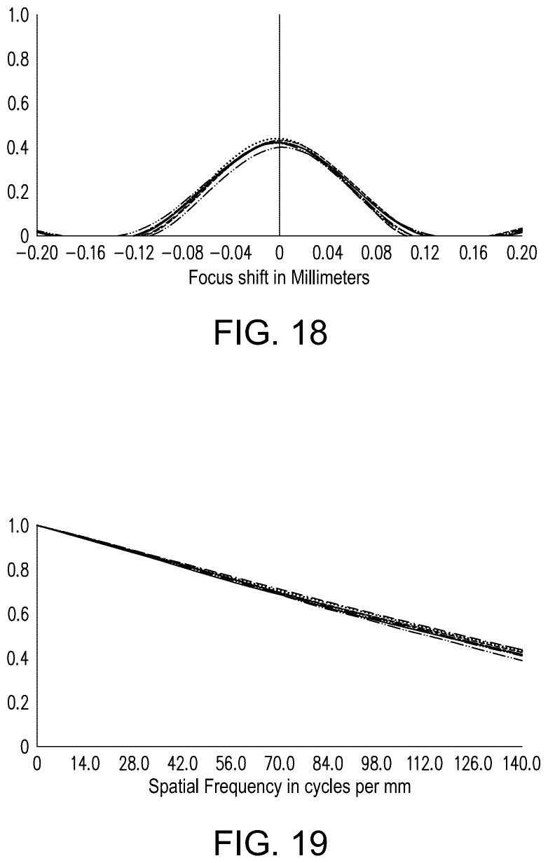

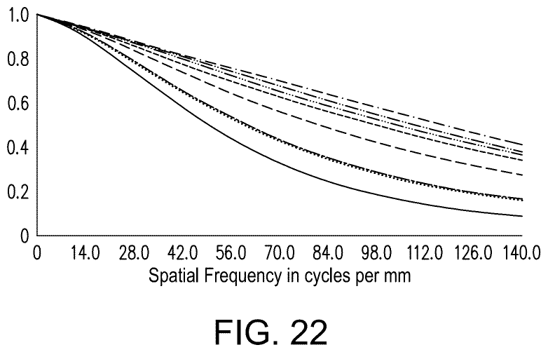

FIG. 16 is a schematic diagram of distortion of the optical imaging lens of FIG. 15. FIG. 17 is a schematic diagram of lateral chromatic aberration distribution of the optical imaging lens of FIG. 15. FIG. 18 to FIG. 22 are modulation transfer function curve diagrams of the optical imaging lens of FIG. 15.

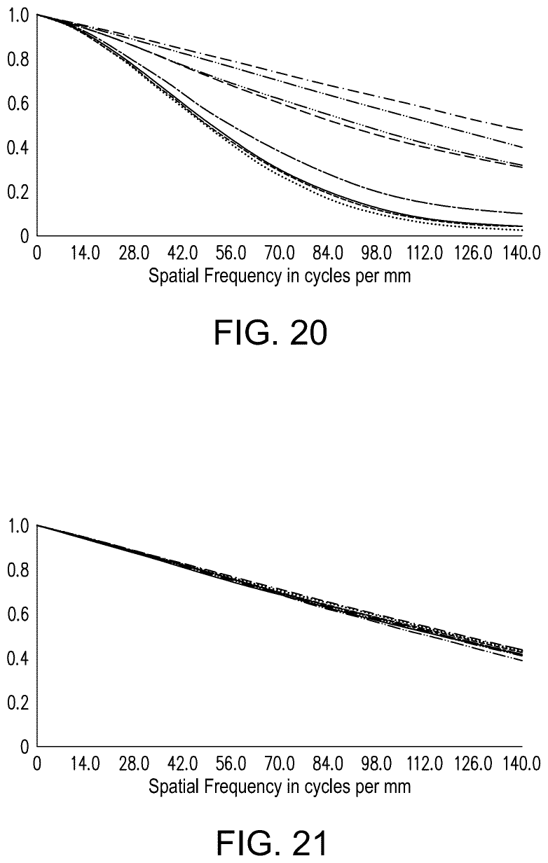

Referring to FIG. 16 to FIG. 22, FIG. 16 illustrates the distortion performance of the optical imaging lens 100B of this embodiment, in which the maximum distortion is −42.684% and the TV distortion is −19.9095%. FIG. 17 shows the lateral chromatic aberration distribution of the optical imaging lens 100B. As shown in the figure, the difference in focal points of the three colors of visible light (RGB) is less than 2 μm. FIG. 18 shows the MTF performance of the optical imaging lens 100B through the focal point at a spatial frequency of 140 lp/mm. FIG. 19 shows the MTF performance of the optical imaging lens 100B not through the focal point at a spatial frequency of 140 lp/mm. FIG. 20 to FIG. 22 respectively show the MTF performance of the optical imaging lens 100B when the object distances are 10 mm, 3 mm, and 2 mm. Therefore, this embodiment may indeed significantly improve optical aberration and provide good optical properties.

By disposing a double-plano component 150 made of glass or plastic immediately after the first lens 110, and then using the grooves or latches formed by the outer skirt of the lens and then applying glue to cure it, the lens molding and stacking assembly of the overall structure of the optical imaging lens 100B may all use resin material injection molding or glass molding technology, which is different from the conventional wafer level optical process lens that uses UV glue molding, where an entire glass substrate is stacked and cured before proceeding with unit segmentation. As a result, the optical imaging lens 100B of this embodiment may simplify the process, improve the production yield, save manufacturing costs, and provide good optical properties.

In addition, when the optical imaging lens of any of the above embodiments further satisfies the following conditional formulas, the optical imaging lens may provide better optical properties: wherein: the optical imaging lenses 100, 100A and 100B comply with: −0.709≥F1/EFL≥−1.235, wherein F1 is the effective focal length of the combination of the first lens 110, the double-plano component 150 and the second lens 120, and EFL is the effective focal length of the optical imaging lenses 100, 100A, and 100B; the optical imaging lenses 100, 100A and 100B comply with: 0.850≥F2/EFL≥0.590, wherein F2 is the effective focal length of the combination of the third lens 130 and the fourth lens 140; the optical imaging lenses 100, 100A and 100B comply with: 2.910≥TTL/ImgC≥1.700, wherein TTL is the distance between the object-side surface 112 of the first lens 110 and the imaging surface IM on the optical axis I, and ImgC is the image circle of the optical imaging lenses 100, 100A and 100B; the optical imaging lenses 100, 100A and 100B comply with: 0.266≥CA1/TTL≥0.150, wherein CA1 is the clear aperture of the first lens 110; and the optical imaging lenses 100, 100A 100B further comply with: 1.200≥DM/ImgC≥0.600, where DM is the diameter of the optical imaging lenses 100, 100A and 100B.

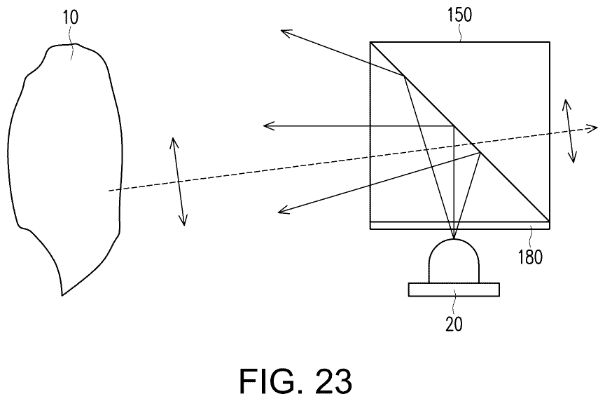

FIG. 23 is a schematic diagram of an application of a double-plano component according to an embodiment of the disclosure. Referring to FIG. 23, the double-plano component 150 shown in this embodiment may be applied to at least all the above embodiments. The following description takes the embodiment of FIG. 1 as an example. In applications such as endoscopes, capsule robots, or eye tracking devices, the double-plano component 150 can, for example, use a polarizing beam splitter (PBS) and be used in conjunction with the light source 20 to allow P-polarized light from the object 10 to pass through and reflect S-polarized light from the light source 20, thereby adjusting the visual color temperature of the object 10 by mixing different RGB color intensities. The light source 20 may be, for example, a mini light-emitting diode (mini LED), a micro light-emitting diode (micro LED), or an optical fiber to provide RGB light or pure white light, but the disclosure is not limited thereto. The beam splitting interface in the double-plano component 150 may be designed such that the ratio of the transmittance of P-polarized light to the reflectance of S-polarized light is 500:1. In this embodiment, a polarizer 180 may be selectively provided to the light source 20 and the double-plano component 150 to adjust the polarization state of the light from the light source 20, but the disclosure is not limited thereto.

To sum up, in an optical fingerprint imaging device of the disclosure, an optical imaging lens includes a first lens, a double-plano component, an aperture, a second lens, a third lens and a fourth lens in sequence from an object side to an image side along an optical axis. Refractive powers of the first lens, the double-plano component, the second lens, the third lens and the fourth lens are negative, zero, negative, positive and positive in sequence. Only the four lenses in the optical imaging lens have non-zero refractive power. A thickness of the double-plano component satisfies the following conditional formula: 0.200≥TE/TTL≥0.049, wherein TE is the thickness of the double-plano component on the optical axis, and TTL is a distance from the object-side surface of the first lens to an imaging surface on the optical axis. Therefore, by disposing a double-plano component made of glass or plastic immediately after the first lens, and then using the grooves or latches formed by the outer skirt of the lens and then applying glue to cure it, the lens molding and stacking assembly of the overall structure of the optical imaging lens may all use resin material injection molding or glass molding technology, which is different from the conventional wafer level optical process lens that uses UV glue molding, where an entire glass substrate is stacked and cured before proceeding with unit segmentation. As a result, the optical imaging lens of this embodiment may simplify the process, improve the production yield, save manufacturing costs, and provide good optical properties.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments may still be modified, or parts or all of the technical features thereof may be equivalently replaced; however, these modifications or substitutions do not deviate the essence of the corresponding technical solutions from the scope of the technical solutions of the embodiments of the disclosure.

What is claimed is:

1. An optical imaging lens, comprising: a first lens, a double-plano component, an aperture, a second lens, a third lens and a fourth lens in sequence from an object side to an image side along an optical axis, wherein the first lens to the fourth lens and the double-plano component each comprise an object-side surface facing the object side and allowing an imaging light to pass through, and an image-side surface facing the image side and allowing the imaging light to pass through; wherein
a material of the double-plano component comprises glass or plastic;
a refractive index of the double-plano component is between 1.450 and 1.850;
refractive powers of the first lens, the double-plano component, the second lens, the third lens and the fourth lens are negative, zero, negative, positive and positive in sequence;
wherein only the four lenses in the optical imaging lens have non-zero refractive power, and a thickness of the double-plano component satisfies a following conditional formula: 0.200≥TE/TTL≥0.049, wherein TE is the thickness of the double-plano component on the optical axis, and TTL is a distance from the object-side surface of the first lens to an imaging surface on the optical axis.

2. The optical imaging lens according to claim 1, wherein an aperture value of the optical imaging lens is between 3.000 and 6.000.

3. The optical imaging lens according to claim 1, wherein the thickness of the double-plano component on the optical axis is between 0.100 mm and 0.550 mm.

4. The optical imaging lens according to claim 1, wherein the optical imaging lens further satisfies a following conditional formula: −0.709≥F1/EFL÷−1.235, wherein F1 is an effective focal length of a combination of the first lens, the double-plano component and the second lens, and EFL is an effective focal length of the optical imaging lens.

5. The optical imaging lens according to claim 1, wherein the optical imaging lens further satisfies a following conditional formula: 0.850≥F2/EFL≥0.590, wherein F2 is an effective focal length of a combination of the third lens and the fourth lens, and EFL is an effective focal length of the optical imaging lens.

6. The optical imaging lens according to claim 1, wherein the optical imaging lens further satisfies a following conditional formula: 2.910≥TTL/ImgC≥1.700, wherein TTL is the distance from the object-side surface of the first lens to the imaging surface on the optical axis, and ImgC is an image circle of the optical imaging lens.

7. The optical imaging lens according to claim 1, wherein the optical imaging lens further satisfies a following conditional formula: 0.266≥CA1/TTL≥0.150, wherein CA1 is a clear aperture of the first lens, and TTL is the distance from the object-side surface of the first lens to the imaging surface on the optical axis.

8. The optical imaging lens according to claim 1, wherein the optical imaging lens further satisfies a following conditional formula: 1.200≥DM/ImgC≥0.600, wherein DM is a diameter of the optical imaging lens, and ImgC is an image circle of the optical imaging lens.

9. The optical imaging lens according to claim 1, wherein an air gap at lens component edges between the first lens to the fourth lens ranges from 0.001 mm to 0.300 mm.

10. The optical imaging lens according to claim 1, wherein the optical imaging lens satisfies one of following conditions: (1) materials of the first lens to the fourth lens are all plastic; (2) materials of the first lens to the fourth lens are all glass; and (3) materials of the first lens and the fourth lens are glass, and materials of the second lens and the third lens are plastic.
